(19) United States
(12) Patent Application Publication
(10) Pub. No.: US 2009/0122253 A1
(43) Pub. Date: May 14, 2009

(54) Eyewear device

(76) Inventor: Michael L. Clay, Willingboro, NJ (US)

Correspondence Address: Michael L. Clay, 11 Shetland Lane, Willingboro, NJ, 08046-1010, US

(21) Appl. No.: 12/288,403

(22) Filed: Oct. 20, 2008

Related U.S. Application Data
(60) Provisional application No. 61/002,434, filed on Nov. 8, 2007.

(51) Int. Cl. G02C 11/02

(52) U.S. Cl. 351/52

(57) ABSTRACT

The present invention relates to a new concept in eyewear, more specifically, an eyewear device with an interchangeable decorative accessory apparatus custom fitted for placement within the side bar of the eyewear device.

This application claims the benefit of priority under 35 U.S.C. §119(e) of U.S. Provisional Patent Application No. 61/002,434 filed on Nov. 08, 2007.

The present invention relates to a new concept in eyewear, more specifically, a fashion eyewear device with an interchangeable decorative accessory apparatus custom fitted for placement within the temple sidebar member of the fashion eyewear device.

Eyewear and more specifically, sunglasses are common accessories amongst individuals globally. Typically, sunglasses are purchased primarily as a fashion statement. One pair of sunglasses offers little variety to the wearer and is difficult to color coordinate with outfits. Furthermore, if these sunglasses become lost, broken, or out of style, the owner is forced to buy another pair of limited use and expensive sunglasses which may inevitably suffer the same fate as the first pair.

Various patents have attempted to solve the problems associated with eyewear by providing changeable parts. U.S. Pat. No. 4,958,923 issued to A. S. Rosenson, discloses removably securing a decorating member to an eyeglass frame member. Although U.S. Pat. No. 4,958,923 offers an alternative to complete replacement of the eyewear for those seeking a change, there still exits a need for an eyewear device that is capable of incorporating fashion accessories into the structure of the eyewear device.

The present invention fulfills this need by providing an eyewear device that is capable of incorporating fashion accessories of multiple shapes, sizes colors, and materials of construction within the structure of the eyewear frame device. The present invention is capable of changing along with fashion, styles, can be coordinated with clothing or event themes and can adapt to the different needs of the user depending on the time or location of use.

Accordingly, the present invention provides a fashion eyewear device comprising

a frame assembly;

at least one lens;

at least two temple sidebars; and

at least one decorative accessory apparatus;

wherein at least a portion of at least one temple sidebar is cut-out and further wherein the at least one decorative accessory apparatus is removably secured within the cutout.

### BRIEF DESCRIPTION OF THE DRAWINGS

Similar reference characters denote corresponding features consistently throughout the attached drawings.

FIG. 1 is an exploded perspective view of the eyewear frame device having a detachable decorative accessory apparatus fitted within the temple sidebar according to the present invention

FIG. 2 is a view of one embodiment of a decorative accessory apparatus.

### DETAILS—REFERENCE NUMERALS

100 lens frame assembly
200 temple sidebar
300 accessory cut-out
400 securing member cut-out
600 decorative accessory apparatus
700 securing members

### DETAILED DESCRIPTION OF THE DRAWINGS

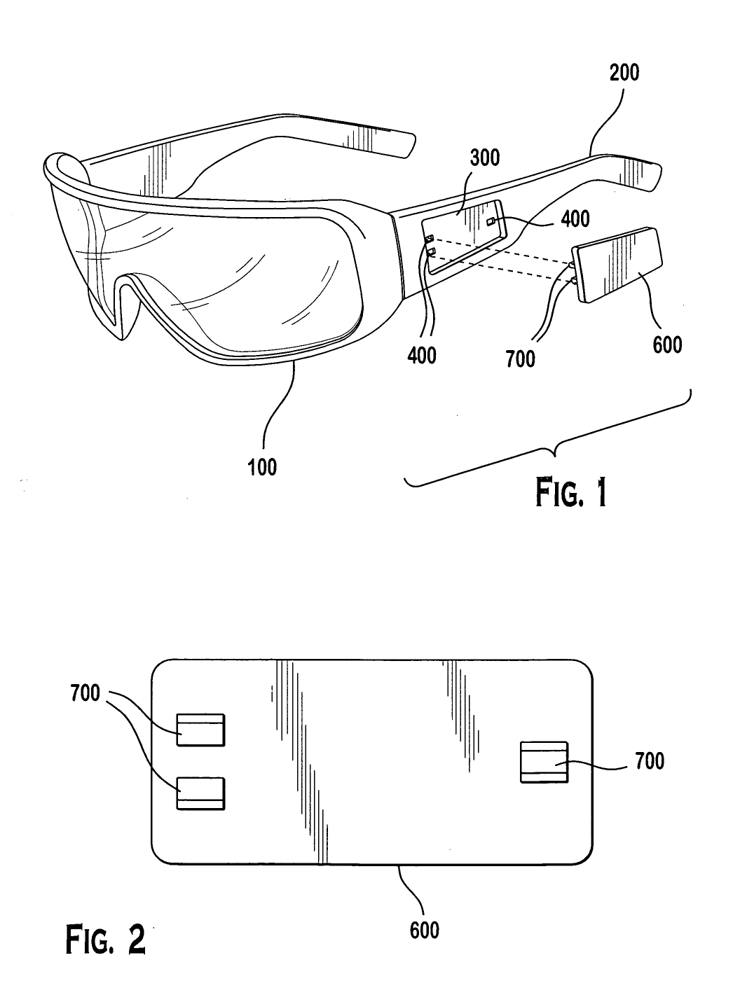

Referring to the drawings, and particularly to FIG. 1, there is shown an eyewear device. The eyewear device comprises one temple side bar member 200 affixed to each side of the lens frame assembly 100. The lens frame assembly 100 comprises at least one lens. The lens may be removable or permanently fixed to the lens frame assembly. The lenses may be constructed of any material known by those of ordinary skill in the art. Some non-limiting examples include plastic, glass, or combinations thereof. The lenses may comprise various shapes, colors, and shades.

The temple sidebar members 200 may be constructed of any material known by those of ordinary skill in the art. Some non-limiting examples include rubber, metal, plastic or combinations thereof. At least a portion of at least one temple sidebar member 200 contains an accessory cut-out 300. One or both of the temple sidebar members 200 may have at least one accessory cut-out 300. Optionally, the temple sidebar member 200 may contain more than one accessory cut-out 300. As used herein “cut-out” is defined as a concave portion in the surface of the temple sidebar member 200 structure. The accessory cut-outs 300 may be any shape and size as long as they are able to be secured within the dimensions of the temple sidebar members 200.

The accessory cut-outs 300 allow for at least one decorative accessory apparatus 600 to be secured within. Optionally, more than one decorative accessory apparatus 600 may be secured within the accessory cut-out 300. Decorative accessory apparatus 600 comprise one or more securing members 700 affixed to the decorative accessory apparatus 600. The decorative accessory apparatus 600 may be removably secured within the securing member cut-out 400. By “removably secured” is meant that the decorative accessory apparatus 600 is able to be detached from the temple side-bar member 200 without undue effort. The affixation of the decorative accessory apparatus 600 within the securing member cut-out 400 in the temple sidebar 200 may be performed by any method known by those of ordinary skill in the art. Non-limiting examples include snap-fitting, use of non-permanent adhesive, and use of magnetic force to secure the decorative accessory apparatus 600 to the securing member cut-out 400. It is an object of the present invention that the decorative accessory apparatus 600 not be permanently affixed but be able to be removed and interchanged with other decorative accessory apparatus 600 of varying shapes, sizes, colors, and materials of construction.

The present invention makes it easy to change the appearance of eyewear in a relatively inexpensive manner. The present invention may be any eyewear device known to those of ordinary skill in the art. Some non-limiting examples include eyeglasses, sunglasses, and goggles.

It is to be understood that the present invention is not limited to the embodiment described above, but encompasses any and all embodiments within the scope of the following claims.

What is claimed is:

1. An improved eyewear device comprising
a frame assembly;
at least one lens;
at least two temple sidebars; and
at least one decorative accessory apparatus;
wherein at least a portion of at least one temple sidebar is cut-out and further wherein the at least one decorative accessory apparatus is removably secured within the accessory cutout.

2. The fashion eyewear device of claim 1 wherein the device is sunglasses.

3. The fashion eyewear device of claim 1 wherein the device is eyeglasses.

4. The fashion eyewear device of claim 1 wherein the device is goggles.

5. The fashion eyewear device of claim 1 wherein the decorative accessory apparatus is snap-fitted within the accessory cut-out.

6. The fashion eyewear device of claim 1 wherein the decorative accessory apparatus is removably secured using magnetic force within the accessory cut-out.

7. The fashion eyewear device of claim 1 wherein the decorative accessory apparatus is removably secured using at least one non-permanent adhesive within the accessory cut-out.

8. The fashion eyewear device of claim 1 wherein at least two decorative accessory apparatus are removably secured within the accessory cutout.
